(19) United States
(12) Patent Application Publication
(10) Pub. No.: US 2026/0277395 A1
(43) Pub. Date: Sep. 17, 2026

(54) OBJECT INFORMATION PRESENTATION METHOD AND APPARATUS, DEVICE, MEDIUM, AND PRODUCT

(71) Applicant: Beijing Zitiao Network Technology Co., Ltd., Beijing (CN)

(72) Inventors: Mengxing XING, Beijing (CN); Zixun LIN, Beijing (CN); Juan WANG, Beijing (CN); Qianwen LI, Beijing (CN); Yiwen ZHANG, Beijing (CN); Lan FENG, Beijing (CN)

(21) Appl. No.: 19/566,745

(22) Filed: Mar. 13, 2026

(30) Foreign Application Priority Data
Mar. 14, 2025 (CN) 202510308794.6

(51) Int. Cl. G06F 3/0482; G06F 3/0483; G06F 3/0485

(52) U.S. Cl. CPC G06F 3/0482; G06F 3/0483; G06F 3/0485

(57) ABSTRACT

Embodiments of the present disclosure provide an object information presentation method and apparatus, a device, a medium, and a product. The method includes: in response to a selection operation performed on a first object list in a first page, presenting a second page, wherein the second page includes a first component and a second component, the first component is used for presenting description information of a first object associated with the selection operation, the second component is used for presenting information of a second object, and the second object includes at least one object; and the at least one object shares at least one object attribute with the first object.

### CROSS-REFERENCE TO RELATED APPLICATION(S)

This application claims priority to Chinese Application No. 202510308794.6 filed on Mar. 14, 2025, the disclosure of which is incorporated herein by reference in its entirety.

### FIELD

Embodiments of the present disclosure relate to the field of computer processing technologies and, in particular, to an object information presentation method and apparatus, a device, a medium, and a product.

### BACKGROUND

In an e-commerce platform, when detailed information of a commodity is presented, it is necessary to link to other commodities; operations such as returning of a detailed information page or adjustment of presentation content of an information column in the detailed information page are required.

### SUMMARY

The present disclosure provides an object information presentation method and apparatus, a device, a medium, and a product. An object description information page and a more object information presentation entry may be used as independent page elements in a page respectively, so that a user may directly obtain more object information on a display page of object description information without increasing operation steps.

In a first aspect, an embodiment of the present disclosure provides an object information presentation method, including:
in response to a selection operation performed on a first object list in a first page, presenting a second page;
wherein the second page includes a first component and a second component; the first component is used for presenting description information of a first object associated with the selection operation; the second component is used for presenting information of a second object; the second object includes at least one object; and the at least one object shares at least one object attribute with the first object.

In a second aspect, an embodiment of the present disclosure provides an object information presentation apparatus, including:
an information presentation module, configured to present a second page, in response to a selection operation performed on a first object list in a first page;
wherein the second page includes a first component and a second component; the first component is used for presenting description information of a first object associated with the selection operation; the second component is used for presenting information of a second object; the second object includes at least one object; and the at least one object shares at least one object attribute with the first object.

In a third aspect, an embodiment of the present disclosure provides an electronic device, including:
one or more processors;
a storage, used to store one or more programs,
when the one or more programs are executed by the one or more processors, the one or more processors are caused to implement the object information presentation method according to any embodiment of the present disclosure.

In a fourth aspect, an embodiment of the present disclosure provides a storage medium including computer-executable instructions, where when the computer-executable instructions are executed by a computer processor, the object information presentation method according to any embodiment of the present disclosure is performed.

In a fifth aspect, an embodiment of the present disclosure provides a computer program product, including a computer program, where when the computer program is executed by a processor, the object information presentation method according to any embodiment of the present disclosure is implemented.

According to the technical solution of the embodiments of the present disclosure, in response to the selection operation performed on the first object list in the first page, the second page is presented; wherein the second page includes the first component and the second component; the first component is used for presenting the description information of the first object associated with the selection operation; the second component is used for presenting the information of the second object; the second object includes at least one object; and the at least one object shares at least one object attribute with the first object.

### BRIEF DESCRIPTION OF THE DRAWINGS

The above and other features, advantages, and aspects of the embodiments of the present disclosure will become more apparent in combination with the drawings and with reference to the following specific implementations. Throughout the drawings, the same or similar reference numerals represent the same or similar elements. It should be understood that the drawings are schematic and that original components and elements are not necessarily drawn to scale.

FIG. 1A is a schematic flowchart of an object information presentation method provided in an embodiment of the present disclosure;

FIG. 1B is a schematic diagram of jumping from a first page to present a second page provided in an embodiment of the present disclosure;

FIG. 2 is a schematic flowchart of another object information presentation method provided in an embodiment of the present disclosure;

FIG. 3 is a schematic flowchart of another object information presentation method provided in an embodiment of the present disclosure;

FIG. 4 is a schematic flowchart of another object information presentation method provided in an embodiment of the present disclosure;

FIG. 5 is a schematic structural diagram of an object information presentation apparatus provided in an embodiment of the present disclosure; and

FIG. 6 is a schematic structural diagram of an electronic device for implementing the embodiments of the present disclosure provided in an embodiment of the present disclosure.

### DETAILED DESCRIPTION OF EMBODIMENTS

Embodiments of the present disclosure will be described in more detail below with reference to the drawings. Although certain embodiments of the present disclosure are shown in the drawings, it should be understood that the present disclosure may be implemented in various forms and should not be interpreted as being limited to the embodiments set forth herein. Instead, these embodiments are provided for a more thorough and complete understanding of the present disclosure. It should be understood that the drawings and embodiments of the present disclosure are only for illustrative purposes and are not intended to limit the protection scope of the present disclosure.

It should be understood that steps described in method implementations of the present disclosure may be performed in different orders and/or in parallel. Furthermore, the method implementations may include additional steps and/or omit performing illustrated steps. The scope of the present disclosure is not limited in this respect.

As used herein, the term “include/comprise” and variations thereof are open-ended inclusions, that is, “include/comprise but not limited to”. The term “based on” is “at least partially based on”. The term “an embodiment” means “at least one embodiment”. The term “another embodiment” means “at least one other embodiment”. The term “some embodiments” means “at least some embodiments”. Related definitions of other terms will be given in the following description.

It should be noted that concepts such as “first” and “second” mentioned in the present disclosure are only used to distinguish different apparatuses, modules, or units, and are not used to limit an order or interdependence of functions performed by these apparatuses, modules, or units.

It should be noted that modifications of “one” and “multiple” mentioned in the present disclosure are illustrative rather than restrictive, and those skilled in the art should understand that “one” or “multiple” should be understood as “one or multiple” unless otherwise clearly indicated in the context.

The names of messages or information exchanged between multiple apparatuses in the implementations of the present disclosure are only for illustrative purposes, and are not intended to limit the scope of these messages or information.

It may be understood that before the use of the technical solution disclosed in the embodiments of the present disclosure, the user should be informed of the type, range of use, use scenarios, etc., of personal information involved in the present disclosure and the authorization of the user should be obtained in an appropriate manner in accordance with relevant laws and regulations.

For example, in response to reception of an active request from a user, prompt information is sent to the user to clearly prompt the user that the requested operation will require access to and use of personal information of the user. As such, the user may independently choose, based on the prompt information, whether to provide the personal information to software or hardware, such as an electronic device, an application, a server, or a storage medium, that performs the operations of the technical solution of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also include a selection control for the user to select whether to “agree” or “disagree” to provide the personal information to the electronic device.

It may be understood that the above process of notifying and acquiring user authorization is only illustrative and does not limit the implementations of the present disclosure, and other manners that satisfy the relevant laws and regulations may also be applied to the implementations of the present disclosure.

It may be understood that data involved in the technical solution (including but not limited to the data itself, acquisition or use of the data) shall comply with requirements of corresponding laws, regulations, and related provisions.

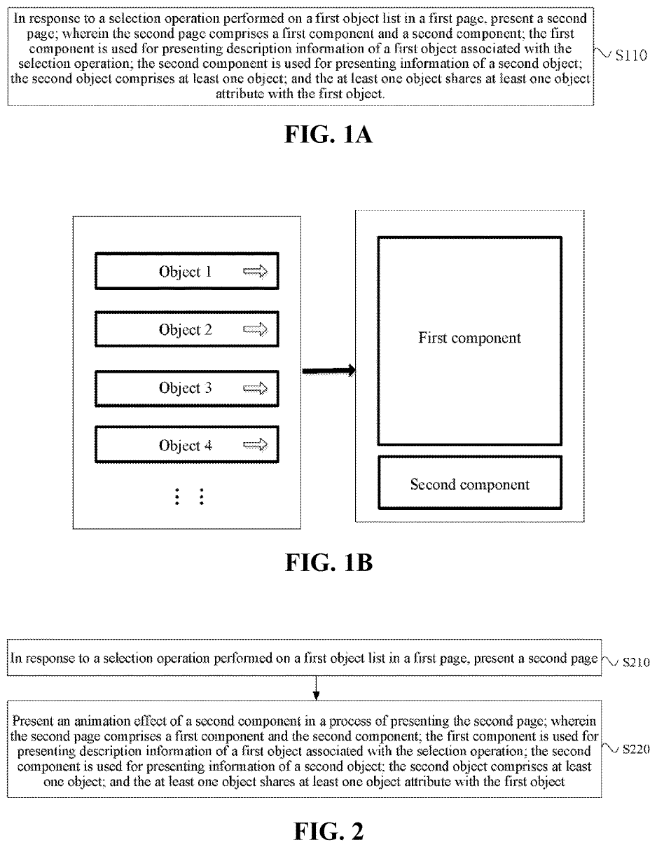

As stated above, in an e-commerce platform, when detailed information of a commodity is presented, a presentation function has a limitation, and information of other commodities cannot be presented at the same time. If it is necessary to link to other commodities, operations such as returning of a detailed information page or adjustment of presentation content of an information column in the detailed information page are required; an operation link for acquiring more commodity information is long, and the information of other commodities cannot be directly provided. FIG. 1A is a schematic flowchart of an object information presentation method provided in an embodiment of the present disclosure. The embodiment of the present disclosure is applicable to a scenario of presenting object description information of an object, and is particularly applicable to a scenario of page jumping between different object information pages. The method may be performed by an object information presentation apparatus, which may be implemented in the form of software and/or hardware. Optionally, the method is implemented by an electronic device, which may be a mobile terminal, a PC, a server, etc.

As shown in FIG. 1A, the object information presentation method in this embodiment may specifically include:

S110: in response to a selection operation performed on a first object list in a first page, a second page is presented; wherein the second page includes a first component and a second component; the first component is used for presenting description information of a first object associated with the selection operation; the second component is used for presenting information of a second object; the second object includes at least one object; and the at least one object shares at least one object attribute with the first object.

Wherein, the first page may be an object presentation page, and the object may be various types of objects such as a commodity, an image, and a news article, or may be a commodity information card containing a commodity, an image, and a function button. An organization form of the objects on the first page may be an object list, a set, a link, or the like.

When the user performs an interaction operation with any first object in the first object list in the first page, the first object associated with the interaction operation may be determined, and the first object is further presented. The interaction operation may be a corresponding selection operation after clicking, sliding, or voice instruction conversion.

To interact with a certain first object may be for further obtaining description information of the first object. When the object is a commodity or a commodity information card, the description information may be detailed description information of the commodity. When the object is an image, the description information may be description information such as an image creator and a creation concept. When the object is a news article, the description information may be news content corresponding to the news article.

Different from the prior art where an information presentation page containing only description information of the first object is directly jumped to from the first page, in the embodiments of the present disclosure, the second page is jumped to from the first page, and the second page includes both the first component and the second component.

It may be understood that the first component and the second component are independent page elements in the second page. Wherein, the first component is used for presenting the description information of the first object associated with the selection operation; the second component is used for presenting the information of the second object; the second object includes at least one object; and the at least one object shares at least one object attribute with the first object.

Furthermore, by sliding the first component, different description information of the first object may be presented. By triggering the second component, the second object may be presented.

Reference may be made to FIG. 1B for a schematic diagram of a process of jumping from the first page to the second page. In FIG. 1B, the left figure is the first page, and multiple objects are presented in the first page. When any object in the first page is triggered, for example, by clicking an arrow symbol on the right side of the corresponding object, the second page may be jumped to. The second page includes two components. The first component presents the description information of the first object. A size of the first component accounts for a larger proportion of a terminal screen area than the second component in a corresponding terminal screen area. The second component may be an information channel for obtaining the second object. In the second page, the description information of the first object in the first page may be browsed only, or the second component may be triggered to be presented.

According to the technical solution of the embodiment of the present disclosure, the first object is determined and the second page is presented by responding to the selection operation performed on the first object list in the first page; wherein the second page includes the first component and the second component; the first component is used for presenting the description information of the first object associated with the selection operation; the second component is used for presenting the information of the second object; the second object includes at least one object; and the at least one object shares at least one object attribute with the first object. The technical solution of the embodiment of the present disclosure solves the problem that there is a limitation in presentation information in an object information presentation page and more object information cannot be directly obtained on a description information page. A description information page and a more object information presentation entry may be used as independent page elements in a page respectively, so that a user can directly obtain more object information on the description information page without increasing operation steps.

FIG. 2 is a schematic flowchart of another object information presentation method provided in an embodiment of the present disclosure. On the basis of the above embodiment, the technical solution of this embodiment further provides a presentation form of the second component. For specific implementations, reference may be made to the description of this embodiment. Wherein, technical features the same as or similar to those in the previous embodiment are not repeated herein.

As shown in FIG. 2, the object information presentation method in this embodiment may specifically include:

S210: in response to a selection operation performed on a first object list in a first page, a second page is presented.

Wherein, each object in the first object list may be presented in the form of an object information card. The object information card may be an independent UI (User Interface) element with a clear boundary and specific content, which is typically used to present specific information or a function module on a web page.

In the object information card, predefined key object information related to the first object may be presented for the user to quickly browse and select the first object. Therefore, the first object may be determined in response to the selection operation for any object in the object list in the first page, and the page is jumped to present the second page.

S220: an animation effect of a second component is presented in a process of presenting the second page; wherein the second page includes a first component and the second component; the first component is used for presenting description information of the first object associated with the selection operation; the second component is used for presenting information of a second object; the second object includes at least one object; and the at least one object shares at least one object attribute with the first object.

Wherein, the animation effect may be any effect that is capable of making the second component present dynamic changes when it is presented, such as a color gradient, size shrinkage and enlargement, or jittering, to attract the attention of the user, so that the second component may be noticed by the user in the second page.

In an optional implementation, the animation effect may be an effect of bubble jittering.

Furthermore, in an optional implementation, the information presented in the second component may be at least one trigger mode for triggering presentation of the second object, so as to prompt the user how to use the second component. Exemplarily, the information may be “slide up or click on this component to obtain more object information”. When the user needs to browse more objects, the user may perform an operation according to the content in the information to obtain more object information without having to return to the first page to obtain more object information.

According to the technical solution of the embodiment of the present disclosure, the second page is presented by responding to the selection operation for any object in the first object list in the first page; and the animation effect of the second component is presented in the process of presenting the second page; wherein the second page includes the first component and the second component; the first component is used for presenting the description information of the first object; the second component is used for presenting the information of the second object; the second object includes at least one object; and the at least one object shares at least one object attribute with the first object. The technical solution of the embodiment of the present disclosure solves the problem that there is a limitation in presentation information in an object information presentation page and more object information cannot be directly obtained on a description information page, and also solves the problem of how to make the second component noticed. A description information page and a more object information presentation entry may be used as independent page elements in a page respectively, and function information of the second component is prompted, so that the user may directly obtain more object information in the case where the description information is presented on a terminal page without increasing operation steps.

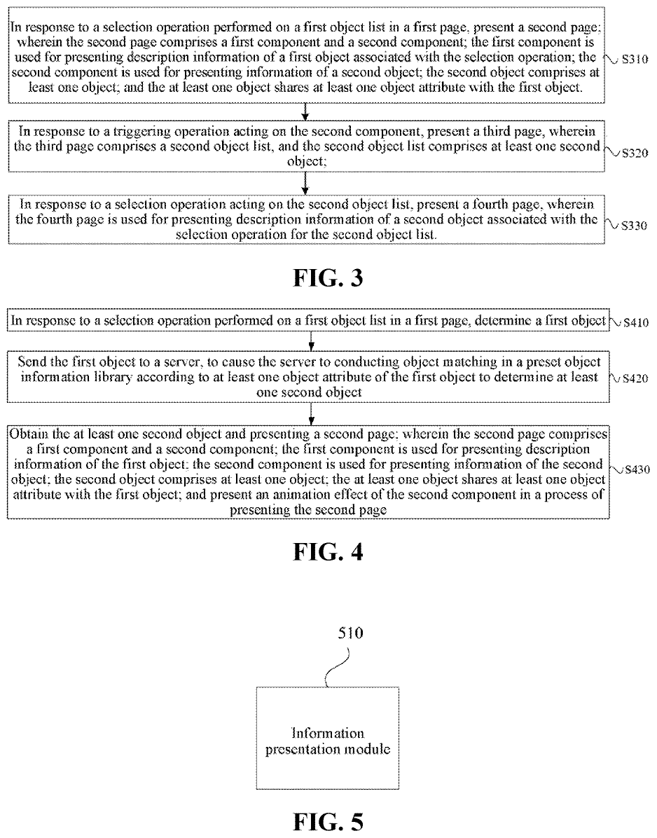

FIG. 3 is a schematic flowchart of another object information presentation method provided in an embodiment of the present disclosure. On the basis of the above embodiments, the technical solution of this embodiment further provides a presentation process of object information of more objects. For specific implementations, reference may be made to the description of this embodiment. Technical features the same as or similar to those in the previous embodiments are not repeated herein.

As shown in FIG. 3, the object information presentation method in this embodiment may specifically include:

S310: in response to a selection operation acting on a first object list in a first page, a second page is presented; wherein the second page includes a first component and a second component; the first component is used for presenting description information of a first object associated with the selection operation; the second component is used for presenting information of a second object; the second object includes at least one object; and the at least one object shares at least one object attribute with the first object.

The first component is used for presenting the description information of the first object. When the user browses the description information of the first object, a sliding distance and a sliding direction may be determined in response to a sliding operation performed on the first component; and information content of the description information of the first object presented in the first component is adjusted according to the sliding distance and the sliding direction. Specifically, the first component and the second component may be page cards, and the first component may be managed by a card container to support sliding inside the page card corresponding to the first component, so that the user may be allowed to see more description information.

S320: a third page is presented, in response to a triggering operation performed on the second component; wherein the third page includes a second object list, and the second object list includes at least one second object.

When the user sends the triggering operation for the second component according to the information on the second component, the third page is jumped to, and the at least one second object the same as the first object in at least one object attribute is presented.

The second object list may also be an object list composed of object information cards of respective second objects. The object information card may be an independent UI element with a clear boundary and specific content, which is used to present specific information or a function module on a web page. It may contain various elements such as text, images, and buttons, and integrate object-related information together to form a relatively independent and complete information unit.

S330: a fourth page is presented in response to a selection operation performed on the second object list; wherein the fourth page is used for presenting description information of a second object associated with a selection operation performed on the second object list.

In this step, description information of any object in the object list composed of the second objects is jumped to and presented. The fourth page where the description information is located includes only one component for presenting the description information, and another component is not nested and presented in the page.

According to the technical solution of the embodiment of the present disclosure, the second page is presented by responding to the selection operation for any object in the first object list in the first page; the third page is presented in response to the triggering operation for the second component; wherein the third page includes the second object list, and the second object list includes at least one second object; and the fourth page is presented in response to the selection operation performed on any object in the second object list; wherein the fourth page is used for presenting the description information of the second object associated with the selection operation performed on any object in the second object list. The technical solution of the embodiment of the present disclosure solves the problem that there is a limitation in presentation information in an object information presentation page and more object information cannot be directly obtained on a description information page. A description information page and a more object information presentation entry can be used as independent page elements in a page respectively, so that a user may further and directly obtain more object information on the description information page without increasing operation steps.

FIG. 4 is a schematic flowchart of another object information presentation method provided in an embodiment of the present disclosure. On the basis of the above embodiments, the technical solution of this embodiment further illustrates a process of determining the second object associated with the first object. For specific implementations, reference may be made to the description of this embodiment. Technical features the same as or similar to those in the previous embodiments are not repeated herein.

As shown in FIG. 4, the object information presentation method in this embodiment may specifically include:

S410: a first object is determined in response to a selection operation performed on a first object list in a first page.

S420: the first object is sent to a server, to cause the server to conduct object matching in a preset object information library according to at least one object attribute of the first object to determine at least one second object.

Wherein, the object attribute includes at least one of an object category, an object search volume, and an object resource replacement business volume. That is, an object similar to the first object is found as the second object through at least one piece of object attribute information.

S430: the at least one second object is obtained, a second page is presented, and an animation effect of a second component is presented in a process of presenting the second page; wherein the second page includes a first component and the second component; the first component is used for presenting description information of the first object; the second component is used for presenting information of the second object; the second object includes at least one object; and the at least one object shares at least one object attribute with the first object.

According to the technical solution of the embodiment of the present disclosure, the first object is determined by responding to the selection operation performed on the first object list in the first page; the first object is sent to the server, to cause the server to perform the object matching in the preset object information library according to the at least one object attribute of the first object to determine the at least one second object; wherein the object attribute includes at least one of the object category, the object search volume, and the object resource replacement business volume; and the at least one second object is obtained and the second page is presented, and the animation effect of the second component is presented in the process of presenting the second page; wherein the second page includes the first component and the second component, the first component is used for presenting the description information of the first object; the second component is used for presenting the information of the at least one second object; the at least one second object includes at least one object; and the at least one object shares at least one object attribute with the first object. The technical solution of the embodiment of the present disclosure solves the problem that there is a limitation in presentation information in an object information presentation page and more object information cannot be directly obtained on a description information page, and solves the problem of how to determine the second object. The second object may be determined according to relevant attribute information of the first object just selected, and a description information page and a more object information presentation entry can be used as independent page elements in the same page respectively, so that the user may directly obtain more object information on the description information page without increasing operation steps.

FIG. 5 is a schematic diagram of a structure of an object information presentation apparatus according to an embodiment of the present disclosure. As shown in FIG. 5, the object information presentation apparatus includes an information presentation module 510.

Wherein, the information presentation module 510 is used to present, in response to a selection operation performed on a first object list in a first page, a second page; wherein the second page includes a first component and a second component; the first component is used for presenting description information of a first object associated with the selection operation; the second component is used for presenting information of a second object; the second object includes at least one object; and the at least one object shares at least one object attribute with the first object.

According to the technical solution of the embodiment of the present disclosure, the second page is presented by responding to the selection operation performed on the first object list in the first page; wherein the second page includes the first component and the second component; the first component is used for presenting the description information of the first object associated with the selection operation; the second component is used for presenting the information of the second object; the second object includes at least one object; and the at least one object shares at least one object attribute with the first object. The technical solution of the embodiment of the present disclosure solves the problem that there is a limitation in presentation information in an object information presentation page and more object information cannot be directly obtained on a description information page. A description information page and a more object information presentation entry can be used as independent page elements in a page respectively, so that a user can directly obtain more object information on the description information page without increasing operation steps.

On the basis of any optional technical solution in the embodiments of the present disclosure, optionally, the information presentation module 510 may be further used to:
present an animation effect of the second component in a process of presenting the second page.

On the basis of any optional technical solution in the embodiments of the present disclosure, optionally, the information includes: at least one trigger mode for triggering presenting the second object.

On the basis of any optional technical solution in the embodiments of the present disclosure, optionally, the information presentation module 510 may be further used to:
present a third page in response to a triggering operation for the second component; wherein the third page includes a second object list, the second object list including at least one second object; and
present a fourth page in response to a selection operation performed on the second object list; wherein the fourth page is used for presenting description information of a second object associated with a selection operation performed on any object in the second object list.

On the basis of any optional technical solution in the embodiments of the present disclosure, optionally, the information presentation module 510 may be further used to:
determine a sliding distance and a sliding direction in response to a sliding operation for the first component; and
adjust information content of the description information of the first object presented in the first component according to the sliding distance and the sliding direction.

On the basis of any optional technical solution in the embodiments of the present disclosure, optionally, a determination process of the second object includes:
conducting object matching in a preset object information library according to at least one object attribute of the first object to determine the at least one second object,
wherein the object attribute includes at least one of an object category, an object search volume, and an object resource replacement business volume.

The object information presentation apparatus provided by the embodiments of the present disclosure may perform the object information presentation method provided by any embodiment of the present disclosure, and has corresponding functional modules and beneficial effects for performing the object information presentation method.

It is worth noting that the units and modules included in the above apparatus are only divided according to functional logic, but are not limited to the above division, as long as the corresponding functions may be implemented. Furthermore, the specific names of the functional units are only for the convenience of distinguishing from each other, and are not used to limit the protection scope of the embodiments of the present disclosure.

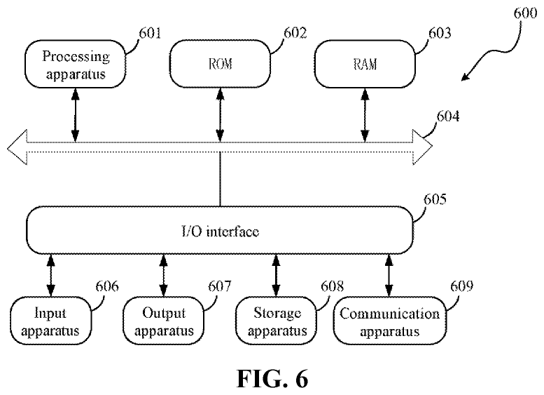

Reference is made to FIG. 6 below, which shows a schematic diagram of a structure of an electronic device (such as a terminal device or a server) 600 suitable for implementing the embodiments of the present disclosure. The terminal device in the embodiments of the present disclosure may include, but is not limited to, a mobile terminal such as a mobile phone, a notebook computer, a digital broadcast receiver, a personal digital assistant (PDA), a tablet computer, a portable multimedia player (PMP), and a vehicle-mounted terminal (such as a vehicle navigation terminal), and a fixed terminal such as a digital TV and a desktop computer. The electronic device shown in FIG. 6 is only an example, and should not impose any limitation on the functions and the range of use of the embodiments of the present disclosure.

As shown in FIG. 6, the electronic apparatus 600 may include a processing apparatus (such as a central processing unit and a graphics processor) 601, which may perform various appropriate actions and processing according to a program stored in a read-only memory (ROM) 602 or a program loaded from a storage apparatus 608 into a random access memory (RAM) 603. The RAM 603 further stores various programs and data required for operations of the electronic apparatus 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touch screen, a touchpad, a keyboard, a mouse, a camera, a microphone, an accelerometer, and a gyroscope; an output apparatus 607 including, for example, a liquid crystal display (LCD), a speaker, and a vibrator; a storage apparatus 608 including, for example, a magnetic tape and a hard disk; and a communication apparatus 609. The communication apparatus 609 may allow the electronic apparatus 600 to perform wireless or wired communication with other apparatuses to exchange data. Although FIG. 6 shows the electronic apparatus 600 having various apparatuses, it should be understood that it is not required to implement or have all of the apparatuses shown. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program contains program code for performing the method shown in the flowchart. In such an embodiment, the computer program may be downloaded and installed from a network via the communication apparatus 609, or installed from the storage apparatus 608, or installed from the ROM 602. When the computer program is executed by the processing apparatus 601, the above-mentioned functions defined in the method of the embodiments of the present disclosure are performed.

The names of messages or information exchanged between multiple apparatuses in the implementations of the present disclosure are only for illustrative purposes, and are not intended to limit the scope of these messages or information.

The electronic apparatus provided by the embodiments of the present disclosure belongs to the same inventive concept as the object information presentation method provided by the above embodiments. For technical details not described in detail in the embodiments of the present disclosure, reference may be made to the above embodiments, and this embodiment has the same beneficial effects as the above embodiments.

An embodiment of the present disclosure provides a computer storage medium having a computer program stored thereon, where the object information presentation method provided by the above embodiments is implemented when the program is executed by a processor.

It should be noted that the above computer-readable medium in the present disclosure may be a computer-readable signal medium, a computer-readable storage medium, or any combination thereof. The computer-readable storage medium may be, for example, but not limited to, an electronic, magnetic, optical, electromagnetic, infrared, or semiconductor system, apparatus, or device, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage apparatus, a magnetic storage apparatus, or any suitable combination thereof. In the present disclosure, the computer-readable storage medium may be any tangible medium that contains or stores a program, which may be used by or in combination with an instruction execution system, apparatus, or device. In the present disclosure, the computer-readable signal medium may include a data signal propagated on a baseband or as a part of a carrier wave, and computer-readable program code is carried thereon. This propagated data signal may be in multiple forms, and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit the program used by or in combination with the instruction execution system, apparatus, or device. The program code contained on the computer-readable medium may be transmitted in any suitable medium, including, but not limited to: a wire, an optical cable, a radio frequency (RF), or any suitable combination thereof.

In some implementations, a client and a server may communicate using any currently known or future developed network protocol, such as hypertext transfer protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The above computer-readable medium may be contained in the above electronic device, or may exist alone without being assembled into the electronic device.

The above computer-readable medium carries one or more programs, and when the one or more programs are executed by the electronic device, the electronic device is caused to:
present a second page, in response to a selection operation performed on a first object list in a first page;
wherein the second page includes a first component and a second component; the first component is used for presenting description information of a first object associated with the selection operation; the second component is used for presenting information of a second object; the second object includes at least one object; and the at least one object shares at least one object attribute with the first object.

The computer program code for performing the operations of the present disclosure may be written in one or more programming languages or a combination thereof, where the programming languages include but are not limited to object-oriented programming languages such as Java, Smalltalk, and C++, and further include conventional procedural programming languages such as “C” language or similar programming languages. The program code may be executed entirely on a user computer, partly executed on a user computer, executed as an independent software package, partly executed on a user computer and partly executed on a remote computer, or entirely executed on a remote computer or server. In the case of involving the remote computer, the remote computer may be connected to the user computer through any kind of network, including a local area network (LAN) or a wide area network (WAN), or may be connected to an external computer (for example, connected through the Internet with the aid of an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules and units involved in the embodiments of the present disclosure may be implemented in a software manner or a hardware manner. The names of the modules and units do not constitute a limitation on the units per se under certain circumstances, and for example, the media data editing module may also be described as “a module for editing the first audio data and determining the first display data of the target display text displayed in association with the first audio data”.

The functions described herein may be at least partially performed by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that can contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium may include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

An embodiment of the present disclosure further provides a computer program product, including a computer program, where the object information presentation method provided by any one of the embodiments of the present disclosure is implemented when the computer program is executed by a processor.

During an implementation of the computer program product, the computer program code for performing the operations of the present disclosure may be written in one or more programming languages or a combination thereof, where the programming languages include object-oriented programming languages such as Java, Smalltalk, and C++, and further include conventional procedural programming languages such as “C” language or similar programming languages. The program code may be executed entirely on a user computer, partly executed on a user computer, executed as an independent software package, partly executed on a user computer and partly executed on a remote computer, or entirely executed on a remote computer or server. In the case of involving the remote computer, the remote computer may be connected to the user computer through any kind of network, including a local area network (LAN) or a wide area network (WAN), or may be connected to an external computer (for example, connected through the Internet with the aid of an Internet service provider).

The above description is merely illustration of preferred embodiments of the present disclosure and applied technical principles. Those skilled in the art should understand that the disclosed scope involved in the present disclosure is not limited to the technical solution formed by a specific combination of the above technical features, and should also cover other technical solutions formed by any combination of the above technical features or equivalent features thereof without departing from the above disclosed concept. For example, the above features and the technical features provided by the present disclosure (but not limited thereto) and having similar functions may be replaced each other to form a technical solution.

Furthermore, although the various operations are depicted in a particular order, this should not be understood as requiring these operations to be performed in the particular order shown or in a sequential order. Under certain circumstances, multitasking and parallel processing may be advantageous. Similarly, although the above discussion contains a number of specific implementation details, these should not be interpreted as limitations on the scope of the present disclosure. Certain features described in the context of separate embodiments may also be implemented in a single embodiment in combination. On the other hand, various features described in the context of a single embodiment may also be implemented in multiple embodiments individually or in any suitable sub-combination.

Although the subject matter has been described in a language specific to structural features and/or method logical actions, it should be understood that the subject matter defined in the appended claims is not necessarily limited to the specific features or actions described above. On the contrary, the specific features and actions described above are merely exemplary forms of implementing the claims.

1. An object information presentation method, comprising:
in response to a selection operation performed on a first object list in a first page, presenting a second page;
wherein the second page comprises a first component and a second component; the first component is used for presenting description information of a first object associated with the selection operation; the second component is used for presenting information of a second object;
the second object comprises at least one object; and the at least one object shares at least one object attribute with the first object.

2. The method of claim 1, further comprising: presenting an animation effect of the second component in a process of presenting the second page.

3. The method of claim 1, wherein the information comprises:
at least one trigger mode for triggering presenting the second object.

4. The method of claim 1, further comprising:
presenting a third page in response to a triggering operation for the second component;
wherein the third page comprises a second object list, the second object list comprising at least one second object; and
presenting a fourth page in response to a selection operation performed on the second object list; wherein the fourth page is used for presenting description information of a second object associated with a selection operation for any object in the second object list.

5. The method of claim 1, further comprising:
determining a sliding distance and a sliding direction in response to a sliding operation for the first component; and
adjusting information content of the description information of the first object presented in the first component according to the sliding distance and the sliding direction.

6. The method of claim 1, wherein a determination process of the second object comprises:
conducting object matching in a preset object information library according to the at least one object attribute of the first object to determine at least one second object;
wherein the object attribute comprises at least one of an object category, an object search volume, and an object resource replacement business volume.

7. The method of claim 1, wherein the first component and the second component are independent page elements in the second page.

8. An electronic device, comprising:
a memory and a processor;
wherein the memory is configured to store one or more computer instructions which, when executed by the processor, cause the processor to:
in response to a selection operation performed on a first object list in a first page, present a second page;
wherein the second page comprises a first component and a second component;
the first component is used for presenting description information of a first object associated with the selection operation; the second component is used for presenting information of a second object; the second object comprises at least one object; and the at least one object shares at least one object attribute with the first object.

9. The device according to claim 8, further comprising instructions causing the processor to:
present an animation effect of the second component in a process of presenting the second page.

10. The device according to claim 8, wherein the information comprises:
at least one trigger mode for triggering presenting the second object.

11. The device according to claim 8, further comprising instructions causing the processor to:
present a third page in response to a triggering operation for the second component;
wherein the third page comprises a second object list, the second object list comprising at least one second object; and
present a fourth page in response to a selection operation performed on the second object list; wherein the fourth page is used for presenting description information of a second object associated with a selection operation for any object in the second object list.

12. The device according to claim 8, further comprising instructions causing the processor to:
determine a sliding distance and a sliding direction in response to a sliding operation for the first component; and
adjust information content of the description information of the first object presented in the first component according to the sliding distance and the sliding direction.

13. The device according to claim 8, wherein a determination process of the second object comprises instructions causing the processor to:
conduct object matching in a preset object information library according to the at least one object attribute of the first object to determine at least one second object;
wherein the object attribute comprises at least one of an object category, an object search volume, and an object resource replacement business volume.

14. The device according to claim 8, wherein the first component and the second component are independent page elements in the second page.

15. A non-transitory computer-readable medium comprising instructions stored thereon which, when executed by a processor, cause the processor to:
in response to a selection operation performed on a first object list in a first page, present a second page;
wherein the second page comprises a first component and a second component; the first component is used for presenting description information of a first object associated with the selection operation; the second component is used for presenting information of a second object; the second object comprises at least one object; and the at least one object shares at least one object attribute with the first object.

16. The medium according to claim 15, further comprising instructions causing the processor to: present an animation effect of the second component in a process of presenting the second page.

17. The medium according to claim 15, wherein the information comprises:
at least one trigger mode for triggering presenting the second object.

18. The medium according to claim 15, further comprising instructions causing the processor to:
present a third page in response to a triggering operation for the second component;
wherein the third page comprises a second object list, the second object list comprising at least one second object; and
present a fourth page in response to a selection operation performed on the second object list; wherein the fourth page is used for presenting description information of a second object associated with a selection operation for any object in the second object list.

19. The medium according to claim 15, further comprising instructions causing the processor to:
determine a sliding distance and a sliding direction in response to a sliding operation for the first component; and
adjust information content of the description information of the first object presented in the first component according to the sliding distance and the sliding direction.

20. The medium according to claim 15, wherein a determination process of the second object comprises instructions causing the processor to:
conduct object matching in a preset object information library according to the at least one object attribute of the first object to determine at least one second object;
wherein the object attribute comprises at least one of an object category, an object search volume, and an object resource replacement business volume.
